(19) United States
(12) Patent Application Publication
(10) Pub. No.: US 2018/0242192 A1
(43) Pub. Date: Aug. 23, 2018

(54) Dynamic Header Compression for Uplink Data for Improving Uplink Link Budget

(71) Applicant: Apple Inc., Cupertino, CA (US)

(72) Inventors: Yingjie Zhao, Pleasanton, CA (US); Li Su, San Jose, CA (US); Murtaza A. Shikari, Mountain View, CA (US); Sethuraman Gurumoorthy, San Jose, CA (US)

(21) Appl. No.: 15/851,857

(22) Filed: Dec. 22, 2017

Related U.S. Application Data
(60) Provisional application No. 62/462,763, filed on Feb. 23, 2017.

(51) Int. Cl. H04W 28/06; H04L 29/06

(52) U.S. Cl. CPC H04W 28/06; H04L 69/04

(57) ABSTRACT

A wireless communication device (UE) may identify a data flow type associated with data packets to be wirelessly transmitted by the wireless communication device over a wireless network during uplink communications. The UE may determine, based on the data flow type, whether to perform header compression for the data packets on a default bearer assigned to the wireless communication device and associated with the data flow for wireless communications over the wireless network. The UE may perform packet header compression for data flow types for which the packet header size is at least a specified percentage of the total packet size. Packet header compression on the default bearer may be enabled at all times, in which case the UE may indicate to the network whether the UE supports header compression on the default bearer. Alternately, the UE may trigger header compression on the default bearer based on application requirements.

### PRIORITY CLAIM

This application claims benefit of priority of U.S. Provisional Patent Application Ser. No. 62/462,763 titled “Dynamic Header Compression for Uplink Data for Improving Uplink Link Budget”, filed on Feb. 23, 2017, which is hereby incorporated by reference as though fully and completely set forth herein.

### FIELD OF THE INVENTION

The present application relates to wireless communications, and more particularly to dynamic header compression for uplink data during wireless communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH, etc.

Various ones of the wireless communications standards, such as LTE, utilize packet switched networks. VoLTE, (Voice over LTE) provisions specific profiles for control and media planes of voice service delivered over LTE. The voice service (control and media planes) are delivered as data flows within the LTE data bearer. VoLTE has considerably higher voice and data capacity than other wireless protocols such as 3G UMTS and 2G GSM. Furthermore, VoLTE's smaller packet headers in comparison to unoptimized VoIP/LTE packets also frees up bandwidth.

Generally, during communications between mobile wireless communication devices or user terminals/devices (UE devices) and wireless networks (or base stations, e.g. eNBs), LTE PDCP (Packet Data Convergence Protocol) header compression, for example RoHC (Robust Header Compression), is currently used only on dedicated bearers such as dedicated bearers for VoLTE. However, in typical LTE configurations, all data—including data for voice applications such as Skype™ and/or FaceTime™, for example—uses the default bearer which does not get the benefit provided by RoHC.

Other corresponding issues related to the prior art will become apparent to one skilled in the art after comparing such prior art with the disclosed embodiments as described herein.

### SUMMARY OF THE INVENTION

Embodiments are presented herein of, inter alia, methods for uplink communications on wireless networks, e.g. on packet data networks, where packet header compression is applied on default bearers during such communications, and of devices that implement the methods. Embodiments are further presented herein for applying header compression on default bearers for uplink communications in wireless communication systems containing user equipment (UE) devices and base stations communicating with each other within the wireless communication systems.

In various embodiments, a wireless communication device (UE) may identify a data flow type associated with data packets that are to be wirelessly transmitted by the wireless communication device over a wireless network during uplink communications of the wireless communication device. The UE may then determine, in response to having identified the data flow type, whether to perform packet header compression for the data packets on a default bearer assigned to the wireless communication device and associated with the data flow for wireless communications over the wireless network. The UE may perform packet header compression for the packets in response to determining that the data flow type is one of a specified number of different data flow types for which the packet header size has been determined to be at least a specified percentage of the total packet size, making packet header compression useful in reducing packet size and thereby reducing power requirements for the UE. In some embodiments, the UE may perform the packet header compression according to a selected context indicating a level of compression and corresponding to a profile associated with the identified data flow type.

When packet header compression on the default bearer is enabled at all times, the UE may send a notification to the wireless network to indicate to the wireless network whether or not the UE supports packet header compression on the default bearer. The UE may transmit the notification in an extended service request message, in a specific defined radio resource control message, or in a specific defined media access control element. When packet header compression on the default bearer is not enabled at all times (or is not enabled by default), the UE may trigger packet header compression on the default bearer. For example, the UE may trigger packet header compression on the default bearer based on requirements of an application executed on the wireless communication device. The UE may trigger the packet header compression on the default bearer by transmitting an extended service request message to the wireless network, by transmitting a specific defined radio resource control message, or by transmitting a specific defined media access control element. The UE may also internally enable/disable packet header compression on the default bearer based on a set of criteria. The criteria may include, but are not limited to, data throughput corresponding to the data flow type, radio conditions associated with the wireless communications over the wireless network, and/or a processing load corresponding to a processing required to perform the packet header compression.

In some embodiments, the UE may control/determine when the data flow corresponding to the identified given data flow type is considered a candidate for packet header compression (e.g. when a TCP flow is a candidate for packet header compression—or when a TCP flow triggers context establishment) by considering a set of criteria for the given data flow type. The criteria may include, but are not be limited to, information from an access point of the wireless communication network, information pertaining to specified application ports associated with respective applications executed on the wireless communication device, a length of time for which the data flow has existed with at least a specified amount of data, and/or a carrier specific address in a carrier bundle.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments; and

FIG. 5 shows an exemplary flow diagram illustrating how packet header compression on default bearers may be implemented, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
ACK: Acknowledge(ment)
AP: Access Point
BS: Base Station
BSR: Buffer Size Report
CPU: Central Processing Unit
DL: Downlink (from BS to UE)
DYN: Dynamic
ESR: Extended Service Request
FDD: Frequency Division Duplexing
FT: Frame Type
FTP: File Transfer Protocol
GPRS: General Packet Radio Service
GSM: Global System for Mobile Communication
IP: Internet Protocol
IR: Initialization and Refresh state
LAN: Local Area Network
LTE: Long Term Evolution
MAC: Media Access Control
NAS: Non-Access Stratum
PDCP: Packet Data Convergence Protocol
PDN: Packet Data Network
PDU: Protocol Data Unit
PT: Payload Type
RAT: Radio Access Technology
RF: Radio Frequency
RoHC: Robust Header Compression
RRC: Radio Resource Control
RTP: Real-time Transport Protocol
RX: Reception/Receive
TCP: Transmission Control Protocol
TDD: Time Division Duplexing
TX: Transmission/Transmit
UDP: User Datagram Protocol
UE: User Equipment
UL: Uplink (from UE to BS)
UMTS: Universal Mobile Telecommunication System
VoLTE: Voice Over LTE
Wi-Fi: Wireless Local Area Network (WLAN) RAT based on the Institute of Electrical and Electronics Engineers' (IEEE) 802.11 standards
WLAN: Wireless LAN

### Terms

The following is a glossary of terms that may appear in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which are mobile or portable. UE devices that perform wireless communications are also referred to as wireless communication devices. Examples of UE devices include mobile telephones or smart phones (e.g., iPhone™, Android™-based phones) and tablet computers such as iPad™, Samsung Galaxy™, etc., portable gaming devices (e.g., Nintendo DS™, PlayStation Portable™, Gameboy Advance™, iPod™), laptops, wearable devices (e.g. Apple Watch™ Google Glass™), PDAs, portable Internet devices, music players, data storage devices, or other handheld devices, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is easily transported by a user.

Base Station (BS)—The term “Base Station” has the full breadth of its ordinary meaning, and at least includes a wireless communication station installed at a fixed location and used to communicate as part of a wireless telephone system or radio system.

Processing Element—refers to various elements or combinations of elements that are capable of performing a function in a device, e.g. in a user equipment device or in a cellular network device. Processing elements may include, for example: processors and associated memory, portions or circuits of individual processor cores, entire processor cores, processor arrays, various analog and/or digital circuitry, circuits such as an ASIC (Application Specific Integrated Circuit), programmable hardware elements such as a field programmable gate array (FPGA), as well as any of various combinations of the above.

Wireless Device (or Wireless Communication Device)—any of various types of computer systems devices which performs wireless communications using WLAN communications, SRAT communications, cellular communications, Wi-Fi communications and the like. As used herein, the term “wireless device” or “wireless communication device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. LTE, CDMA, GSM), such as a base station or a cellular telephone, for example.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

BLUETOOTH™—The term “BLUETOOTH™” has the full breadth of its ordinary meaning, and at least includes any of the various implementations of the Bluetooth standard, including Bluetooth Low Energy (BTLE) and Bluetooth Low Energy for Audio (BTLEA), including future implementations of the Bluetooth standard, among others.

Personal Area Network—The term “Personal Area Network” has the full breadth of its ordinary meaning, and at least includes any of various types of computer networks used for data transmission among devices such as computers, phones, tablets and input/output devices. Bluetooth is one example of a personal area network. A PAN is an example of a short range wireless communication technology.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

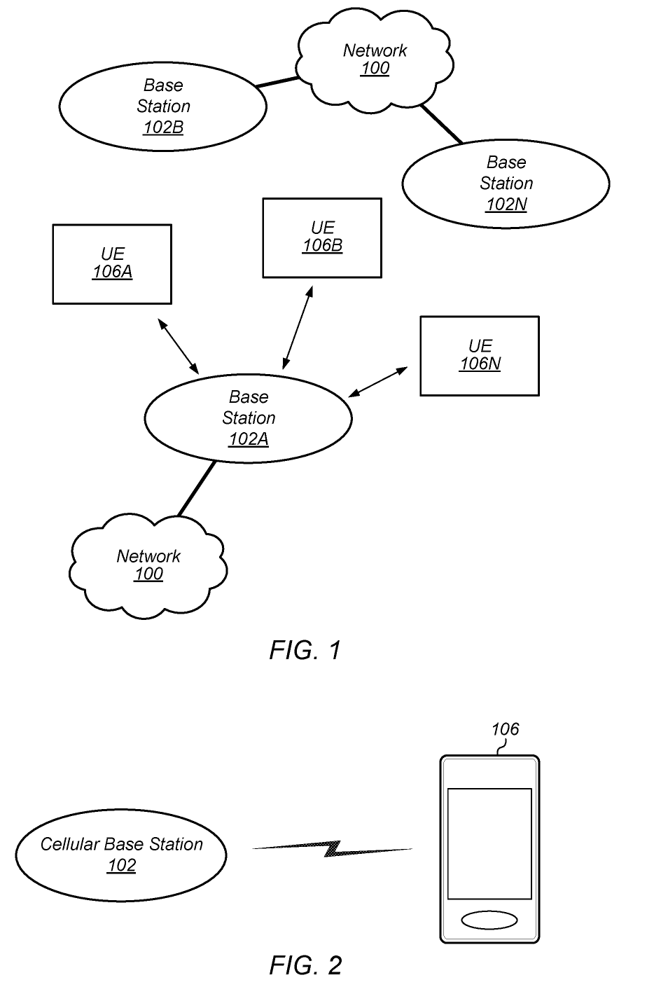

### FIGS. 1 and 2—Exemplary Communication System

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more user devices 106-1 through 106-N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware that enables wireless communication with the UEs 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network. It should also be noted that “cell” may also refer to a logical identity for a given coverage area at a given frequency. In general, any independent cellular wireless coverage area may be referred to as a “cell”. In such cases a base station may be situated at particular confluences of three cells. The base station, in this uniform topology, may serve three 120-degree beam-width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads).

The base station 102 and the user devices may be configured to communicate over the transmission medium using any of various radio access technologies (RATs), also referred to as wireless communication technologies, or telecommunication standards, such as GSM, UMTS (WCDMA), 5G (New Radio), LTE, LTE-Advanced (LTE-A), 3GPP2 CDMA2000 (e.g., 1×RTT, 1×EV-DO, HRPD, eHRPD), Wi-Fi, WiMAX etc. In some embodiments, the base station 102 communicates with at least one UE using improved UL (Uplink) and DL (Downlink) decoupling, preferably through LTE or a similar RAT standard.

UE 106 may be capable of communicating using multiple wireless communication standards. For example, a UE 106 might be configured to communicate using either or both of a 3GPP cellular communication standard (such as LTE) or a 3GPP2 cellular communication standard (such as a cellular communication standard in the CDMA2000 family of cellular communication standards), and/or other cellular communication standard (e.g. 5G-NR). In some embodiments, the UE 106 may be configured to communicate with base station 102 using dynamic header compression (e.g. RoHC) applied on default bearers, for example for uplink communications, as described herein. Base station 102 and other similar base stations operating according to the same or a different cellular communication standard may thus be provided as one or more networks of cells, which may provide continuous or nearly continuous overlapping service to UE 106 and similar devices over a wide geographic area via one or more cellular communication standards.

The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

FIG. 2 illustrates an exemplary user equipment 106 (e.g., one of the devices 106-1 through 106-N) in communication with the base station 102, according to some embodiments. The UE 106 may be a device with wireless network connectivity such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. In some embodiments, the UE 106 may include any processing element(s) that perform any of the method embodiments described herein. For example, the UE 106 may include any one or more of a processor, FPGA, custom circuitry, application specific integrated circuit and/or system on a chip interoperating to execute/perform any of the method embodiments described herein. The UE 106 may be configured to communicate using any of multiple wireless communication protocols. For example, the UE 106 may be configured to communicate using two or more of CDMA2000, LTE, LTE-A, WLAN, 5G-NR, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios which are shared between multiple wireless communication protocols, and one or more radios which are used exclusively by a single wireless communication protocol. For example, the UE 106 may include a shared radio for communicating using either of LTE or CDMA2000 1×RTT, and separate radios for communicating using each of Wi-Fi and BLUETOOTH′. Other configurations are also possible.

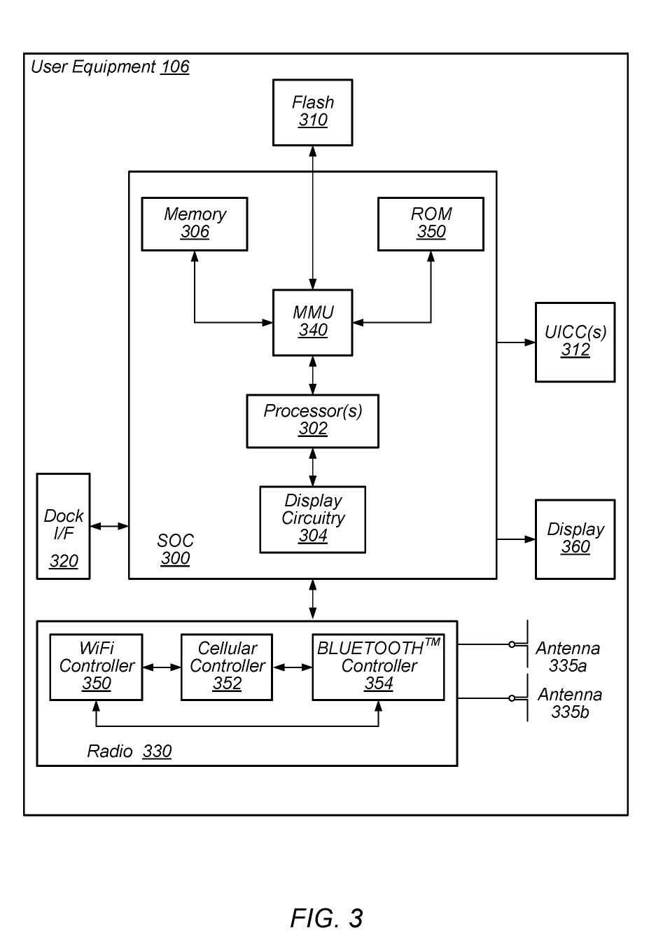

### FIG. 3—Block Diagram of an Exemplary UE

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio (circuitry) 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry 330 (e.g., for LTE, LTE-A, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include more antennas. Overall, the one or more antennas (including 335a and 335b) are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for applying dynamic header compression (e.g. RoHC) on default bearers, for example for wireless uplink communications, which may reduce power consumption and thereby improve the uplink link-budget of UE 106. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 that incorporates improved link estimation and power saving according to various embodiments disclosed herein. Specifically, processor(s) 302 may be coupled to and/or may interoperate with other components as shown in FIG. 3 to facilitate UE 106 communicating various uplink grant requirements to the network (e.g. to base station 102) in order for base station 102 to provide UL grants that more closely and accurately match actual data requirements of UE 106. Processor(s) 302 may also implement various other applications and/or end-user applications running on UE 106.

In some embodiments, radio (circuitry) 330 may include separate controllers dedicated to controlling communications for various respective RAT standards. For example, as shown in FIG. 3, radio 330 may include a Wi-Fi controller 350, a cellular controller (e.g. LTE controller) 352, and BLUETOOTH™ controller 354, and in at least some embodiments, one or more or all of these controllers may be implemented as respective integrated circuits (ICs or chips, for short) in communication with each other and with SOC 300 (and more specifically with processor(s) 302). For example, Wi-Fi controller 350 may communicate with cellular controller 352 over a cell-ISM link or WCI interface, and/or BLUETOOTH™ controller 354 may communicate with cellular controller 352 over a cell-ISM link, etc. While three separate controllers are illustrated within radio 330, other embodiments may have fewer or more similar controllers for various different RATs that may be implemented in UE device 106, and radio 330 may be implemented as any number of different controllers for facilitating wireless communications according to various respective wireless standards, for example as shown in FIG. 3, or in a single controller, or any combination as desired.

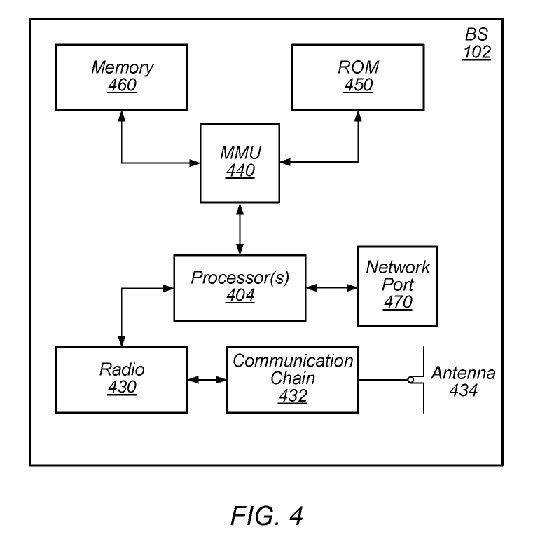

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be designed to communicate via various wireless telecommunication standards, including, but not limited to, LTE, LTE-A WCDMA, CDMA2000, etc. The processor(s) 404 of the base station 102 may be configured to implement part or all of the methods described herein for base station 102 to issue UL grants that more accurately and closely match actual data requirements of a UE device, e.g., by executing program instructions stored on a memory medium (e.g., a non-transitory computer-readable memory medium). Alternatively, the processor(s) 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard. Base station 102 may operate according to the various methods as disclosed herein for providing more accurate UL grants to mobile devices.

### Default Bearers and Dedicated Bearers

For wireless communications over a given wireless network, a bearer defines how the UE data is treated when it travels across the given wireless network. The network might treat some data in a special way and treat other data normally. For example, some data flow—or data flow type(s)—might be provided a guaranteed bit rate while other data flows (or data flow type(s)) may have lower transfer rates. In one sense, a bearer is a set of network parameters defining data-specific treatment. For example, a first UE may always be provided a guaranteed download data rate of at least 256 Kbps while a second UE may not be provided a guaranteed bit rate and at times might face extremely low download speeds.

When a UE attaches to an LTE network for the first time, it is assigned a default bearer which remains as long as the UE remains connected on the network. In one sense, a default bearer represents best effort service. Each default bearer comes with an IP address, and a UE may have multiple default bearers, each default bearer having a different corresponding IP address. In general, a default bearer is the first EPS (Evolved Packet System) bearer established to a particular packet network. An EPS bearer is typically composed of three parts: the radio bearer (the over-the air portion), the S1-U bearer (between the base station and the serving gateway) and the S5 bearer (between the serving gateway and the packet data network gateway).

In contrast to a default bearer, a dedicated bearer provides a dedicated tunnel to one or more specific traffic types (i.e. VoIP, video, etc.). A dedicated bearer represents an additional bearer next to the default bearer. A dedicated bearer does not require a separate IP address as only additional default bearers require different IP addresses. A dedicated bearer is therefore always linked to one of the previously established default bearers. A dedicated bearer may be a guaranteed bitrate (GBR) or non-GBR bearer, whereas a default bearer is a non-GBR bearer. For services like VoLTE, dedicated bearers provide a better user experience by using traffic flow templates to give special treatment to specific services. For example, LTE networks with VoLTE implementations typically have two default bearers and one dedicated bearer. The first default bearer is used for signaling messages related to the Internet Protocol Multimedia Subsystem network. The dedicated bearer is used for VoLTE VoIP traffic and is linked to the first default bearer. Finally, the second default bearer is used for all other smartphone traffic (video, chat, email, browser etc.).

### Header Compression

RoHC (Robust Header Compression) is used to compress overhead bytes in a packet into typically one or three bytes by placing a compressor before a given link having limited capacity, and placing a decompressor after the given link. The compressor converts the large overhead to a few bytes, while the decompressor performs the corresponding inverse operation. The RoHC compression scheme generally performs well over links where the packet loss rate is high, such as wireless links. RoHC has three modes of operation: a unidirectional mode (U-mode), a bidirectional optimistic mode (O-mode), and a bidirectional reliable mode (R-mode). Both the compressor and the decompressor start in U-mode, and may then transition to O-mode if a usable return link is available, and the decompressor sends a positive acknowledgement, with O-mode specified, to the compressor. The transition to R-mode is achieved in the same way. The RoHC compressor defines three states: the Initialization and Refresh (IR) State, the First Order (FO) State, and Second Order (SO) State. RoHC packets and various packet types may be formed corresponding/according to the various modes and states described above.

As previously mentioned, during communications between mobile wireless communication devices or user terminals/devices (UE devices) and wireless networks (or base stations, e.g. eNBs), LTE PDCP header compression, namely, RoHC (Robust Header Compression) is used only on dedicated bearers such as dedicated bearers for VoLTE. However, in typical LTE configurations, all data—including data for voice applications such as Skype™ and/or FaceTime™, for example—uses the default bearer which does not get the benefit that can be obtained from using RoHC. In other words, there are applications using default bearers that might benefit from header compression, for example from RoHC. Generally, when the header size is greater relative to the payload size of a packet, benefits may be gained from using RoHC.

### Dynamic Header Compression on Default Bearer for Uplink

Pursuant to at least the above, it may therefore be advantageous to apply header compression on the default bearer. Accordingly, certain specific steps and/or processes may be devised to enable dynamic header compression (e.g. RoHC) on default bearer(s).

In order to determine when and in what manner header compression may be applied to default bearer(s), all uplink (UL) data may be classified as belonging to one of a number of different IP flows or IP flow types. In some embodiments, the IP flows (or IP flow types) may be categorized as belonging to one of three different flow types.
1. RTP/UDP/IP flows may be generated, for example, when using certain applications or application types, such as Skype™, FaceTime™, and/or various kinds of audio applications. In RTP/UDP data flows, or in the case of RTP/UDP flow types, the packet size is relatively small (e.g. 100 bytes), and the IP/UDP/RTP header may occupy nearly 40% of the whole packet size. In other words, the packet header may make up 40% of the entire packet size, and header compression may therefore dramatically reduce packet size, and may consequently also reduce TX power for the transmission, thereby enhancing the UL link budget of the wireless communication device.
2. TCP flows with small packet size (e.g. 100 bytes) may be generated when using certain applications such as web browsing, texting applications (e.g. iMessaging™), etc. and may include long-life (long lived) TCP flows and short-life (short lived) TCP flows. The packet size for such data flows is small, therefore the TCP/IP header may occupy nearly half of the whole packet size. In other words, the packet header may make up nearly 50% of the entire packet size, and header compression may therefore dramatically reduce packet size and consequently also reduce TX power for the transmission, enhancing the UL link budget for the wireless communication device.
3. TCP flows with large packet size do not fall into either of the above two categories as they feature large packets which may occur during certain applications, for example during FTP put operations and the like.
   It should be noted that while three data packet flow types are specified above, additional flow types may be introduced as various communications standards (e.g. wireless communications standards) continue to develop. In such cases, the different and/or additional types may equally be taken into consideration in a manner similar to what is shown above.

Based on the UL data (or data flow or data flow type) classification above, packet headers may be compressed, e.g. using RoHC, by enabling header compression for the default bearer(s), which may be accomplished in one of several ways.
1. A first option may be to trigger header compression (e.g. RoHC) on the default bearer(s) on demand, based on the needs and/or requirements of a given application. For example, header compression for the default bearer(s) may be triggered when an audio application is started. The trigger methods may include any one or more of the following, (identified as one-way dynamic triggering): a NAS message, such as and Extended Service Request message to the network (e.g. to a serving base station of the network), a specific defined RRC message, and/or a specific defined MAC control element.
2. A second option may feature having header compression enabled/configured on the default bearer(s) at all times. In such cases the UE may use different methods to notify the network or indicate to the network whether the UE can support header compression on the default bearer(s). Some examples of the signaling/messaging means the UE may use to provide such indication/notification to the network include, but are not limited to: a NAS message such as and ESR, a specific defined RRC message, and/or a specific defined MAC control element.

Once header compression has been configured/enabled on the default bearer(s), the UE may use any of a number of different contexts indicating the level of compression. In some embodiments, the UE may use three different profiles, for example with RoHC, the following profiles may be used:

1. Profile 0x00: no compression

2. Profile 0x06: TCP/IP compression

3. Profile 0x02: UDP/IP compression.

Thus, the UE may still have control over whether header compression is to be performed and if so, what level of compression to apply to the packet headers. Furthermore, as also noted with respect to the data flow types presented above, additional and/or different profile designations are possible and are contemplated as various communications standards evolve and develop. Furthermore, in case of different compression methods/algorithms, different profiles corresponding to or associated with the employed compression method/algorithm may be used to indicate the specified level of compression for the various different data flows.

The UE may use local filtering to identify/determine the data flow associated with the packets to be transmitted. For example, the UE may have local filters that the UE uses to match UL packets to one of the different data flows indicated above. If the packets are matched to UDP/IP flows, which may be generated from certain types of applications, (for example from audio applications such as FaceTime™, Skype™, etc.), the UE may use header compression according to Profile 0x02, which may reduce the packet size, for example from 100 bytes to 40 bytes. If the packets are matched to TCP/IP flows with small packet size, which may be generated by certain types of applications, (for example from a browser, or from TCP ACKs), the UE may use header compression according to Profile 0x01, which may reduce the packet size, for example by at least 40% of the original packet size. For any packets that the UE could not successfully match to any of the designated packet flows, the UE may use profile 0, and the packet may therefore not be compressed, which may increase the packet size by one byte due to the additional byte representing the compression header.

When applying RoHC for UL TCP flows, short-lived TCP transfers may degrade the performance of header compression schemes that establish a new context whereupon initially transmitted packet(s) include full headers. Though a solution for context replication exists, making the context establishment steps faster and more efficient by replicating part of an existing context to a new flow, too many contexts still consume much more CPU memory and CPU power, and may therefore degrade overall RoHC TCP performance.

Accordingly, the local filters used by the UE to identify/classify the data flows (or used to identify/determine the data flow types) may be optimized to control/identify TCP flows that may trigger context establishment. Therefore, the local filters to identify TCP data flows may be created based on any one or more of the following:
1. Information from the AP.
2. Specified application ports (e.g. web server, iMessage™ server, Siri™, etc.)
3. The length of time for which the TCP data flow has existed with at least a specified amount of data.
4. A carrier specific address in a carrier bundle.
   Consequently, the TCP flows that match the filter specification(s) may be identified as data flows that can trigger context establishment. More generally, a data flow corresponding to a data flow type initially considered for packet header compression may be analyzed/filtered based on a set of criteria to determine whether the data flow is a candidate for packet header compression. The example above is in reference to TCP data flows and provides possible criteria that may be used in determining whether packet header compression is justified for a given TCP data flow.

Additionally, unused and/or less-used header compression contexts (e.g. RoHC contexts) may be removed based on any one or more of the following:
1. No data has been transmitted on the given context for at least a specified amount of time.
2. A command from AP.
3. The end of the TCP flow—(e.g. TCP Finished packet).
5. A higher priority TCP flow has been detected, allowing the higher priority TCP flow to take over the RoHC context used by lower priority TCP flows.

In some embodiments, the UE may internally enable or disable UL header compression (e.g. UL RoHC) for the default bearer(s) by passing UL data to established RoHC contexts (e.g. Profile 0x01 or Profile 0x02), or to the specific RoHC context with Profile 0 (no compression) based on any one or more of the following conditions:
1. High data throughput vs. low data throughput—for a given data flow with high data throughput, the header may make up a very small portion of the entire packet size, therefore the compression benefit(s) may be negligible. Accordingly, header compression (on the default bearer(s)) may be temporarily disabled on the given data flow.
2. Good radio condition vs. bad radio condition—a bad radio condition may suggest a reduced link budget, therefore header compression (on the default bearer(s)) on small packets provides added benefit.
3. CPU load—since the header compression increases the CPU load (e.g. by adding a processing load corresponding to the processing required to perform packet header compression), the CPU power usage may be monitored not to exceed a specified load level due to header compression, and if the excess CPU load (stemming from executing/performing the header compression) exceeds a specified level, the UL data may be passed to the Profile 0 context.

Benefits of dynamic header compression on default bearer(s) as disclosed herein include, among others, the ability for the UE to enable/disable header compression (e.g. RoHC) on a per RRC connection basis, without requiring an intermittent exchange indicative of the UE capability via additional RRC signaling. It also allows optimal interworking with capacity/coverage starved cellular networks.

### Exemplary Method for Establishing Packet Header Compression on Default Bearer(s) for UL

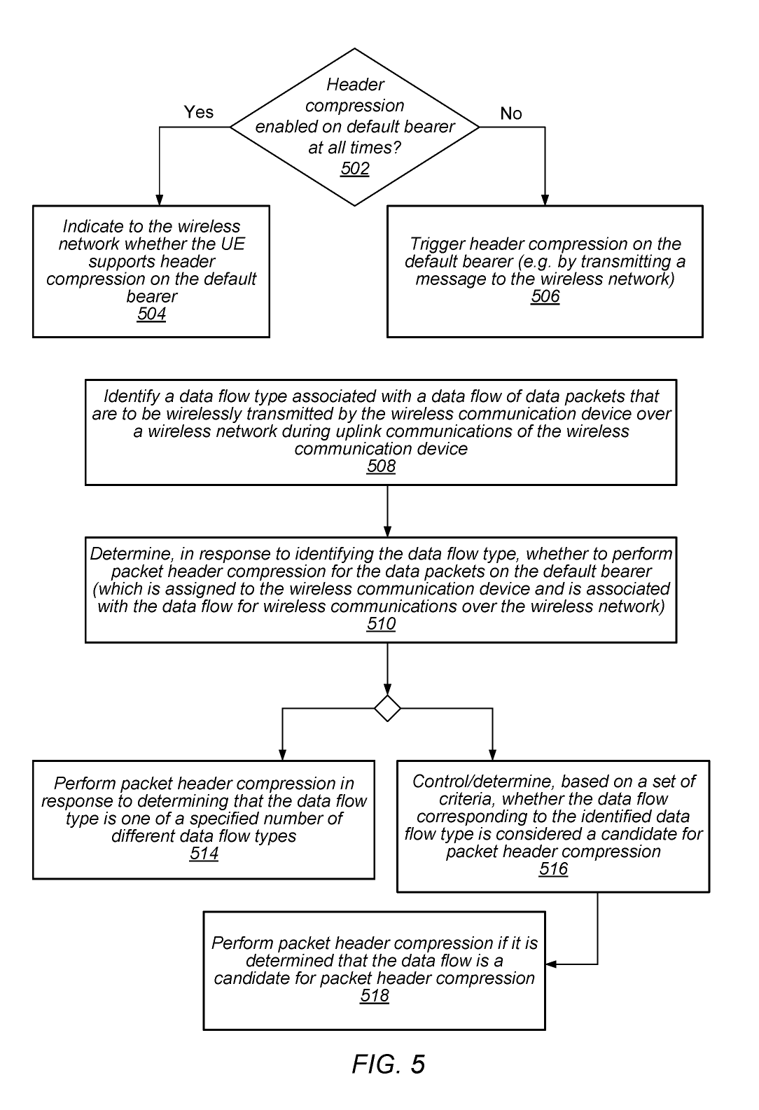

FIG. 5 shows an exemplary flow diagram illustrating how packet header compression on default bearers may be implemented, according to various embodiments. In some embodiments, packet header compression on the default bearer may be enabled at all times (“Yes” branch at 502). In such cases, the UE may indicate to the wireless network whether or not the UE supports packet header compression on the default bearer (504). The UE may indicate such support (or lack thereof) by transmitting a notification to the wireless network (e.g. to a serving base station in the wireless network) in an extended service request message, a specific defined radio resource control message, or a specific defined media access control element. When packet header compression on the default bearer is not enabled at all times (“No” branch at 502), the UE may trigger packet header compression on the default bearer, e.g. by transmitting a message to the wireless network (506). In some embodiments, the UE may trigger packet header compression on the default bearer based on requirements of an application executed on the wireless communication device. The UE may trigger the packet header compression on the default bearer by transmitting an extended service request message to the wireless network, a specific defined radio resource control message, or a specific defined media access control element. The UE may also internally enable/disable packet header compression on the default bearer based on a set of criteria, which may include data throughput corresponding to the data flow type, radio conditions associated with the wireless communications over the wireless network, and/or a processing load corresponding to a processing required to perform the packet header compression.

With packet header compression on default bearers enabled, the UE may identify a data flow type associated with a data flow of data packets that are to be wirelessly transmitted by the wireless communication device over the wireless network during uplink communications of the wireless communication device (508). The UE may then determine, in response to having identified the data flow type, whether to perform packet header compression for the data packets on the default bearer (which is assigned to the wireless communication device and is associated with the data flow for wireless communications over the wireless network—510).

In some cases, the UE may perform packet header compression for the packets in response to determining that the data flow type is one of a specified number of different data flow types (514). The specified number of different data flow types may correspond to data flows for which packet header size has been determined to be at least a specified percentage of a total packet size, and which would therefore benefit from packet header compression in reducing packet size and thereby also reducing power requirements for the UE. In some embodiments, the UE may perform the packet header compression according to a selected context indicating a level of compression and corresponding to a profile associated with the identified data flow type.

In some cases, the UE may control/determine, based on a set of criteria, whether the data flow corresponding to the identified data flow type is considered a candidate for packet header compression (516). The criteria may include information from an access point of the wireless communication network, information pertaining to specified application ports associated with respective applications executed on the wireless communication device, a length of time for which the data flow has existed with at least a specified amount of data, and/or a carrier specific address in a carrier bundle. The UE may perform packet header compression if it is determined that the data flow is a candidate for packet header compression based on the set of criteria (518).

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
a non-transitory memory element configured to store information; and
a processing element configured to use at least a portion of the information stored in the non-transitory memory element to cause a wireless communication device to:
identify a data flow type associated with a data flow comprising data packets to be wirelessly transmitted by the wireless communication device over a wireless network during uplink communications of the wireless communication device; and
determine, in response to having identified the data flow type, whether to perform packet header compression for the data packets on a default bearer assigned to the wireless communication device and associated with the data flow for wireless communications over the wireless network.

2. The apparatus of claim 1, wherein the processing element is configured to further cause the wireless communication device to:
perform packet header compression for the data packets in response to determining that the data flow type is one of a plurality of data flow types for which packet header size is at least a specified percentage of a total packet size.

3. The apparatus of claim 2, wherein the processing element is configured to further cause the wireless communication device to perform the packet header compression according to a selected context indicating a level of compression, wherein the selected context corresponds to a profile associated with the data flow type.

4. The apparatus of claim 1, wherein when packet header compression on the default bearer is enabled at all times, the processing element is configured to further cause the wireless communication device to send a notification to the wireless network, wherein the notification indicates to the wireless network whether the wireless communication device supports packet header compression on the default bearer.

5. The apparatus of claim 4, wherein the processing element is configured to further cause the wireless communication device to transmit the notification in one of:
an extended service request message;
a specific defined radio resource control message; or
a specific defined media access control element.

6. The apparatus of claim 1, wherein the processing element is configured to further cause the wireless communication device to:
trigger packet header compression on the default bearer based on requirements of an application executed on the wireless communication device.

7. The apparatus of claim 6, wherein the processing element is configured to further cause the wireless communication device to trigger the packet header compression on the default bearer via one of:
an extended service request message transmitted to the wireless network;
a specific defined radio resource control message; or
a specific defined media access control element.

8. The apparatus of claim 1, wherein the processing element is further configured to cause the wireless communication device to determine whether the data flow corresponding to the data flow type is a candidate for packet header compression based on one or more of the following:
information from an access point of the wireless communication network;
information pertaining to specified application ports associated with respective applications executed on the wireless communication device;
a length of time for which a data flow of the data flow type has existed with at least a specified amount of data; or
a carrier specific address in a carrier bundle.

9. The apparatus of claim 1, wherein the processing element is further configured to cause the wireless communication device to internally enable packet header compression on the default bearer based on one or more of the following:
data throughput corresponding to the data flow type;
radio conditions associated with the wireless communications over the wireless network; or
a processing load corresponding to a processing required to perform the packet header compression.

10. A wireless communication device comprising:
radio circuitry configured to facilitate wireless communications of the wireless communication device; and
control circuitry communicatively coupled to the radio circuitry and configured to cause the wireless communication device to:
identify a data flow type associated with a data flow comprising data packets to be wirelessly transmitted by the wireless communication device over a wireless network during uplink communications of the wireless communication device; and
determine, in response to having identified the data flow type, whether to perform packet header compression for the packets on a default bearer assigned to the wireless communication device and associated with the data flow for wireless communications over the wireless network.

11. The wireless communication device of claim 10, wherein the processing element is configured to further cause the wireless communication device to:
perform packet header compression for the packets in response to determining that the data flow type is one of a plurality of data flow types for which packet header size is at least a specified percentage of a total packet size; and
perform the packet header compression according to a specified level of compression corresponding to the data flow type.

12. The wireless communication device of claim 10, wherein the processing element is configured to further cause the wireless communication device to:
when packet header compression on the default bearer is enabled at all times, send a notification to the wireless network, wherein the notification indicates to the wireless network whether the wireless communication device supports packet header compression on the default bearer, and wherein the notification is sent in in one of:
an extended service request message;
a specific defined radio resource control message; or
a specific defined media access control element.

13. The wireless communication device of claim 12, wherein the processing element is configured to further cause the wireless communication device to:
trigger packet header compression on the default bearer based on requirements of an application executed on the wireless communication device, wherein the packet header compression on the default bearer is triggered via one of:
an extended service request message transmitted to the wireless network;
a specific defined radio resource control message; or
a specific defined media access control element.

14. The wireless communication device of claim 10, wherein the processing element is configured to further cause the wireless communication device to determine whether the data flow corresponding to the data flow type is a candidate for packet header compression based on one or more of the following:
information from an access point of the wireless communication network;
information pertaining to specified application ports associated with respective applications executed on the wireless communication device;
a length of time for which a data flow of the data flow type has existed with at least a specified amount of data; or
a carrier specific address in a carrier bundle.

15. The wireless communication device of claim 10, wherein the processing element is configured to further cause the wireless communication device to internally enable packet header compression on the default bearer based on one or more of the following:
data throughput corresponding to the data flow type;
radio conditions associated with the wireless communications over the wireless network; or
a processing load corresponding to a processing required to perform the packet header compression.

16. A non-transitory memory medium storing programming instructions executable by a processing element to cause a wireless communication device to:
identify a data flow type associated with a data flow comprising data packets to be wirelessly transmitted by the wireless communication device over a wireless network during uplink communications of the wireless communication device; and
determine, in response to having identified the data flow type, whether to perform packet header compression for the packets on a default bearer assigned to the wireless communication device and associated with the data flow for wireless communications over the wireless network.

17. The non-transitory memory medium of claim 16, wherein the programming instructions are further executable by the processing element to cause the wireless communication device to:
perform packet header compression for the packets in response to determining that the data flow type is one of a plurality of data flow types for which packet header size is at least a specified percentage of a total packet size; and
perform the packet header compression according to a specified level of compression corresponding to the data flow type.

18. The non-transitory memory medium of claim 16, wherein the programming instructions are further executable by the processing element to cause the wireless communication device to trigger packet header compression on the default bearer based on requirements of an application executed on the wireless communication device.

19. The non-transitory memory medium of claim 16, wherein the programming instructions are further executable by the processing element to cause the wireless communication device to determine whether the data flow corresponding to the data flow type is a candidate for packet header compression based on one or more of the following:
information from an access point of the wireless communication network;
information pertaining to specified application ports associated with respective applications executed on the wireless communication device;
a length of time for which a data flow of the data flow type has existed with at least a specified amount of data; or
a carrier specific address in a carrier bundle.

20. The non-transitory memory medium of claim 16, wherein the programming instructions are further executable by the processing element to cause the wireless communication device to internally enable packet header compression on the default bearer based on one or more of the following:
data throughput corresponding to the data flow type;
radio conditions associated with the wireless communications over the wireless network; or
a processing load corresponding to a processing required to perform the packet header compression.
